(19) United States
(12) Patent Application Publication
(10) Pub. No.: US 2010/0116059 A1
(43) Pub. Date: May 13, 2010

(54) VIBRATION SENSOR HAVING A SINGLE VIRTUAL CENTER OF MASS

(75) Inventors: Livne Gan, Midreshet Ben Gurion (IL); Sever-Yoan Mican, Tel-Hashomer (IL); Lior Nachum, Yavne (IL)

Correspondence Address: Fleit Gibbons Gutman Bongini & Bianco PL, 21355 EAST DIXIE HIGHWAY, SUITE 115, MIAMI, FL, 33180, US

(73) Assignee: Spider Technologies Security Ltd., Lod (IL)

(21) Appl. No.: 12/691,809

(22) Filed: Jan. 22, 2010

Related U.S. Application Data
(63) Continuation-in-part of application No. 11/572,520, filed on Jan. 23, 2007, now Pat. No. 7,673,515.
(60) Provisional application No. 60/590,896, filed on Jul. 26, 2004.

(51) Int. Cl. G01N 29/02

(52) U.S. Cl. 73/592

(57) ABSTRACT

A vibration sensor enabling measuring a vibratory signal in a single virtual center of mass of the sensor including a chamber within the housing exhibiting a chamber center and chamber surface wherein all portions of the chamber surface are substantially equidistant from chamber center; and two pairs of vibration-sensitive transducers, wherein each transducer has a body including a first end portion, a second end portion and a central axis segment passing axially through the center of the body, between the first end portion and the second end portion; and wherein the first end portion includes a transuding element receptor portion; and wherein the second end portion is in operative association with the housing and each transducer pair of the two or more transducer pairs and includes an axis passing through the central segment of a first transducer, the chamber center, and the central segment of a second transducer.

### CROSS REFERENCE TO RELATED APPLICATIONS

This application claims the benefit of U.S. Provisional Patent Application 60/978,448, filed Oct. 9, 2007, which is incorporated herein by reference in its entirety.

### TECHNICAL FIELD

The present invention relates to a vibration sensor having multiple transducers in contact with fluid contained within a sensor chamber.

### BACKGROUND OF THE INVENTION

Determining the direction and/or intensity of vibrations provides valuable information in many diverse technological fields, for example, seismic plotting of an earthquake, locating tunnel activity, and intrusion event detection.

A common prior art vibration sensor comprises a transducer in contact with fluid in a chamber. As the fluid vibrates in response to vibrations that contact the chamber, the transducer produces a signal that is received by a signal interpreter. The interpreter uses the signal to characterize vibrations in magnitude, frequency or vector along an axis passing through the fluid.

To characterize a vibration in multiple axes, multiple sensors, each having a different axis, for example, are coupled together or alternatively, the sensor is rotated and/or moved with respect to the vibration; as seen in the following exemplary patents:

In U.S. Pat. No. 4,525,819, Hartley, John Edward teaches a geophone transducer that is partially submerged in a fluid and detects horizontal seismic waves.

In U.S. Pat. No. 4,334,296, Hall Jr., Ernest M. teaches a geophone comprising a fluid filled chamber having transducers in flexible top and bottom walls. Multiple geophones are used to provide output signals relating to the direction of the earth's motion.

Prior to setting forth the background of the invention in detail, it may be helpful to set forth definitions of certain terms that will be used hereinafter.

The term “vibration” as used herein in this application, may refer, for example, to an oscillation of a particle, particles, or elastic solid or surface, back and forth across a central position wherein the oscillation may or may not be periodic. Vibrations may originate in, inter alia, mechanical, hydrological or geological systems. Any vibration may be characterized by a changing level of spatial pressure exhibiting a measurable frequency and amplitude.

The term “transducer” as used herein in this application, may refer, for example, to a device that converts the energy deriving from a pressure of a shock or a vibratory motion into another type of signal such as optical, mechanical, electrical signal or any other signal such that the converted signal is proportional to one or more motion parameters of the original vibratory signal.

The term “transducing element” as used herein in this application, may refer, for example, to the portion of the transducer that converts the pressure energy of the vibration motion into a different type of signal.

One of the challenges of vibration sensors is to determining the direction and the intensity of vibrations in various environments. Quantitative tempo-spatial information regarding vibrations is a valuable in many diverse technological fields, for example, seismic plotting of an earthquake, locating tunnel activity, and intrusion event detection. While various vibrations sensors are known in the art, the characteristics and therefore the limitations of such vibrations sensors are usually dictated by the particular technology of the transducers that are used to implement the vibration sensors.

It would be therefore advantageous to provide a technology independent vibration sensor that enables tempo spatial measurements of vibration signals.

### BRIEF SUMMARY

An aspect of an embodiment of the present invention comprises a vibration sensor that simultaneously provides output signals along multiple axes of a vibration, the sensor having a vibration-transmitting housing surrounding a chamber, the chamber containing a fluid and having a surface substantially in contact with the fluid.

In an exemplary embodiment, the sensor further includes two or more paired vibration transducers positioned around the chamber, each transducer having a body including a first end; a second end; and a central axis segment between the first and second ends that passes through the center of the body, each body including a port adapted to communicate with a signal interpreter.

Each first transducer end is operatively associated with the housing. Each second transducer end includes a transducing element operatively associated with the chamber fluid.

In an exemplary embodiment, a first transducer pair and a second transducer pair are paired around the chamber so that a first axis passes through a first transducer of each pair, the center of the chamber and through a second transducer of each pair; the first and second transducer pairs providing vibration information from the center of the chamber.

In an exemplary embodiment, the axes passing through the first and second transducer pairs are planar and perpendicular to each other. Planar axes, as used herein, refer to axes that lie along a single flat plane.

In an exemplary embodiment, the sensor includes at least a third axis containing a transducer pair similarly paired in the manner of the first and second transducer pairs.

Optionally, at least three of the three axes passing through the transducer pairs are perpendicular to each other and thereby characterize vibrations in the X-, Y-, and Z-axes.

In an alternative exemplary embodiment, each transducer in at least one pair of transducers includes an amplification housing to amplify the vibrations.

A further aspect of the present invention comprises a method for measuring a vibration, using at least one first pair and at least one second pair of transducers.

As used herein, the word “fluid” designates “a continuous amorphous substance that tends to flow and to conform to the outline of its container” (Word Web© 2005) and includes any liquid or powder suspended in liquid comprising an inertial mass that is responsive to vibrations.

As used herein, “vibration” refers to the response of the chamber fluid to motion or oscillations outside the chamber originating in, inter alia, mechanical or geological systems; the chamber fluid vibration pressure being measurable in frequency and amplitude. (“Harris' Shock and Vibration Handbook”, Fifth Edition; Edited by Cyril M. Harris and Allan G. Piersol)

As used herein, “transducer” refers to a device that converts the pressure of a shock or a vibratory motion into an optical, mechanical or electrical signal that is proportional to one or more motion parameters.

As used herein, “transducing element” refers to the portion of the transducer that converts the pressure of the vibration motion into a signal. (ibid)

There is thus provided a vibration sensor and method for measuring vibrations, the sensor having two or more paired transducers, the sensor comprising a chamber within a housing, the chamber including a center, a surface in which all portions of the surface are substantially equidistant from the chamber center and a volume of a vibration-sensitive fluid substantially in contact with the surface.

The sensor further includes two or more pairs of vibration-sensitive transducers, wherein each transducer of each of the two or more pairs is adapted to communicate with at least one signal interpreter. Each transducer has a body including a first end portion, a second end portion and a central axis segment passing axially through the center of the body, between the first end portion and the second end portion.

The first end portion is operatively associated with the chamber surface and includes a transducing element receptor portion, at least a portion of the transducing element portion being substantially in contact with the fluid. The second end portion is in operative association with the housing and each transducer pair of the two or more transducer pairs includes an axis passing through the central segment of a first transducer, the chamber center, and the central segment of a second transducer.

Optionally, the signal interpreter provides at least one of adding and subtracting the signals generated by each of the at least two pairs of transducers.

In an exemplary embodiment, the axes of the two or more transducer pairs are planar and at least one first axis passing through at least one first transducer pair is at least one of perpendicular and obliquely angled, with respect to at least one second axis passing through at least one second transducer pair.

Alternatively, the at least two transducer pairs comprise at least three transducer pairs, and the at least one third transducer pair that is at least one of:

Planar, and oblique with respect to the plane of the at least two planar transducer pairs and the at least one third transducer pair axis is perpendicular to the plane of the at least two transducer pairs.

Optionally, the at least three transducer pairs comprise at least four transducer pairs, and include at least one fourth transducer pair angled 45 degrees to the two or more planar axes.

Optionally, each transducer of at least one transducer pair includes an amplification housing.

An aspect of an embodiment of the present invention comprises a vibration sensor having one or more paired transducers, the sensor comprising a chamber within a housing, the chamber including a center, a surface in which all portions of the surface are substantially equidistant from the chamber center and a volume of a vibration-sensitive fluid substantially in contact with the surface.

In an exemplary embodiment, the present invention further includes one or more pairs of vibration-sensitive transducers, wherein each transducer is adapted to communicate with at least one signal interpreter, each transducer further having a body that includes a first end portion with a cross sectional area, a second end portion, and a central axis segment passing axially through the center of the body between the first end portion and the second end portion.

The first end portion, including a transducing element receptor portion and an amplification housing, comprises a support element projecting from the body and beyond the transducing element, the support including one or more walls that surround an amplification fluid and a membrane attached to the support element and enclosing the amplification fluid, the membrane further including an area in contact with the chamber fluid, the contact area being substantially greater than the first end portion cross section.

The second end portion is in operative association with the housing and each transducer pair of the one or more transducer pairs includes an axis passing through the central segment of a first transducer, the chamber center and the central segment of a second transducer.

An aspect of the present invention further includes a method for measuring a vibration from four or more equidistant points, comprising centering a chamber surface around a center point, filling the chamber with fluid, measuring a fluid vibration from at least four measuring points juxtaposed against the chamber surface, wherein at least two measuring points are located along a first axis passing through the center point and at least two measuring points are located along a second axis passing through the center point. Optionally, two or more of the at least four measuring points comprise transducers having amplification housings.

An aspect of the present invention includes a method for measuring a vibration from two or more equidistant points, comprising centering a chamber surface around a center point, containing a fluid within the surface, juxtaposing two or more vibration measuring elements in juxtaposition with the surface, placing an amplification housing over the two or more vibration measuring elements and measuring a fluid vibration from at least two measuring points juxtaposed against the chamber surface; wherein at least two measuring points are located along an axis passing through the center point.

Accordingly, it is a principal object of the present invention to overcome the disadvantages of the prior art. This is provided in the present invention by implementing the concept of sensing a vibratory tempo spatial signal in a virtual center of mass of the disclosed vibration sensor. Moreover, the disclosed implementation of the vibration sensor is technology independent in relation to the type of transducer used and thus enables the use of any type of transducers such as pressure sensors, speed sensor, acceleration sensors and the like

In embodiments of the present invention, there is provided a method of measuring a vibratory signal in a single virtual center of mass of a vibration sensor, the method comprising: centering a chamber surface around a center point; and measuring vibration from at least four measuring points in juxtaposition with the chamber surface, wherein at least two measuring points are located along a first axis passing through the center point and at least two measuring points are located along a second axis passing through the center point.

In embodiments, there is further provided a vibration sensor enabling measuring a vibratory signal in a single virtual center of mass of the sensor. The vibration sensor comprises: a chamber within the housing exhibiting a chamber center and chamber surface wherein all portions of the chamber surface are substantially equidistant from chamber center; and at least two pairs of vibration-sensitive transducers, wherein each transducer has a body including a first end portion, a second end portion and a central axis segment passing axially through the center of the body, between the first end portion and the second end portion; and wherein the first end portion is operatively associated with the chamber surface and includes a transuding element receptor portion; and wherein the second end portion is in operative association with the housing and each transducer pair of the two or more transducer pairs and includes an axis passing through the central segment of a first transducer, the chamber center, and the central segment of a second transducer.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows a schematic view of a vibration sensor system, in accordance with an embodiment of the present invention;

FIG. 2 shows a detailed exploded view of the vibration sensor of FIG. 1, in accordance with an embodiment of the present invention; and

FIG. 3 shows a pressure transducer having an amplification diaphragm, in accordance with an embodiment of the present invention.

FIG. 4 is a high level flowchart showing a method of measuring a vibratory signal according to some embodiments of the present invention;

FIG. 5 is a high level schematic block diagram showing a system for measuring a vibratory signal according to some embodiments of the present invention;

FIG. 6 is a high level schematic mechanical diagram showing a vibration sensor according to some embodiments of the present invention; and

FIG. 7 is a high level schematic block diagram showing a sensor signal processor according to some embodiments of the invention.

The drawings together with the description make apparent to those skilled in the art how the invention may be embodied in practice.

### DETAILED DESCRIPTION OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Embodiments of the present invention provide a method, device and a system for measuring a vibration from an even number of equidistant points located within a chamber.

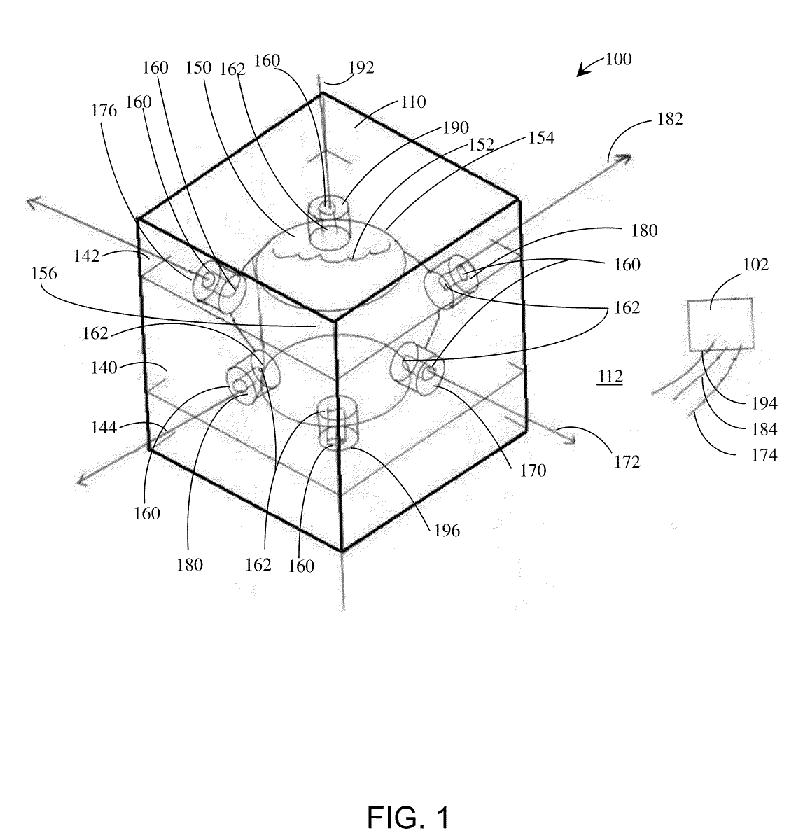

Vibration Sensor Operation. FIG. 1 shows a schematic view of an exemplary embodiment of a vibration sensor 100 having a central, substantially spherical chamber 150, including a spherical surface 154 and a center 156. Chamber 150 contains a volume of fluid 152 and is surrounded by a housing 100 comprising a material adapted to transmit vibrations from an outside volume 112 to fluid 152, comprising, for example, a material including metal and/or plastic.

In an exemplary embodiment, chamber 150 includes six bores arranged into three pairs aligned with each of three axes 172, 182, and 192. A first bore 170 and a second bore 176 each have a central axis segment substantially aligned with an X-axis 172 that passes through center 156. A third bore 180 and a fourth bore 186 each have a central axis segment substantially aligned with a Y-axis 182 that passes through center 156. A fifth bore 190 and a sixth bore 196 each have a central axis segment substantially aligned with a Z-axis 192 that passes through center 156.

A vibration pressure transducer 160 is affixed, for example, with glue in each of bores 170, 176, 180, 186, 190 and 196, and includes a transducing element 162 substantially in contact with, and responsive to, the pressure of fluid 152 vibrations passing through chamber 150.

In an exemplary embodiment, a signal interpreter 102 is connected to each transducer 160 via paired cables 174, 184 and 194. X-axis paired cables 174 connect interpreter 102 to transducers 160 in bores 170 and 176. Y-axis cables 184 connect interpreter 102 to transducers 160 in bores 180 and 186. Z-axis cable 194 connect interpreter 102 to transducers 160 in bore 190 and 196.

Optionally, cables 174, 184 and 194, for example, comprise four electrical wires, two wires connecting to each transducer 160.

As used herein, the term “transducer 160” refers to any active or passive transducer 160, whose signal can be characterized by voltage, current amplitude, frequency, or phase. Active transducers 160 generate electrical signals from energy taken from the physical phenomenon being measured and include piezoelectric and inductive transducers 160. Passive transducers 160 measure the effect of the physical phenomenon on resistivity, capacity, or inductivity of an electric current and include resistive, capacitive, inductive, and optoelectronic transducers 160; some examples being Electret Condensers and coiled wire and magnet arrangements.

Alternatively, cables 174, 184 and 194 include wave guides and transducers 160 that transmit wave signals, for example, in infra red frequencies. In still other embodiments, each transducer provides a wireless signal that is received by receptor 102.

In an exemplary embodiment, signal interpreter 102 records information provided by the output of each transducer 160 individually and processes and/or analyzes the signal either during or following recording; using any one of the many signal analysis processes known in the art.

By way of example, interpreter 102 adds or subtracts signals from each set of two transducers 160 located on the X-172, Y-182 and/or Z-192 axes, thereby amplifying or attenuating signals and/or eliminating extraneous diffuse vibration noise; diffuse vibration noise referring to vibrations with the same amplitude and phase coming from all directions.

The resultant signal information from X-172, Y-182 and Z-192 axes is then processed by interpreter 102 to characterize a three-dimensional state of energy state of fluid 152 at center 156 along the X-172, Y-182 and/or Z-192 axes. This characterization, for example, provides frequency and magnitude information so that one sensor 100 can be used in place of multiple prior art sensors that each record along a single axis.

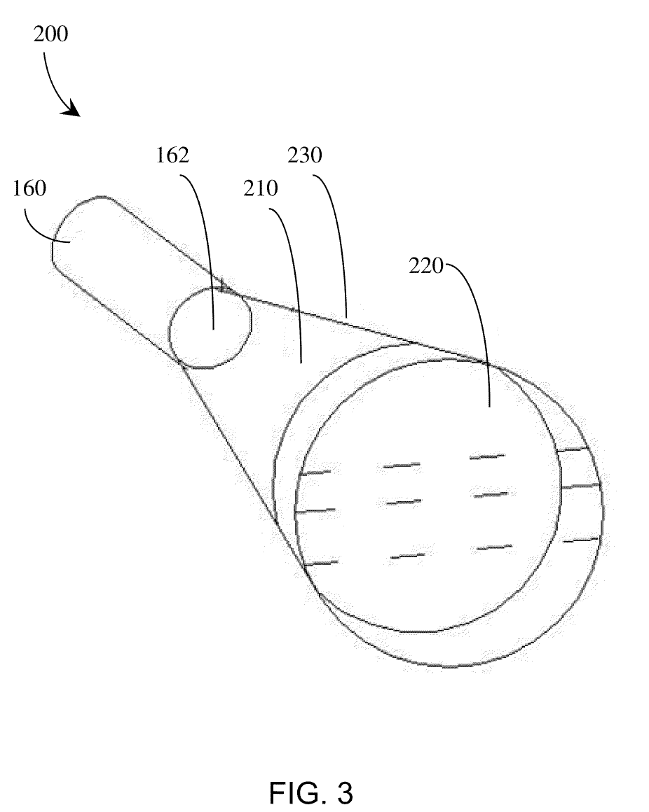

FIG. 3 shows an exemplary embodiment in which transducer 160 is modified to be responsive to weak signals. Modified transducer 160 includes an amplification housing 200 comprising a substantially rigid conical wall 230 having a vibration amplification membrane 220 that includes a large surface area. Wall 230, membrane 220, and a transducing element 262 enclose a volume of compressible amplification fluid 210, for example, a gas.

The pressure of each vibration against membrane 220 causes membrane 220 to deform wherein the pressure of fluid 210 is inversely proportional to volumetric changes according to the following formula:

$${P}_{1} = Po \cdot \frac{Vo}{{V}_{1}} ;$$

wherein:
Po=the pressure variation applied on membrane 220;
P1=the pressure variation measured by transducing element 262;
Vo=the volume of fluid 210 before pressure Po is applied; and
V1=the volume of fluid 210 after pressure variation Po is applied.

Based upon the above formula, vibration pressure on membrane 220 results in an elevated vibration pressure on transducing element 262; the resultant signal, for example, aiding interpreter 102 in distinguishing weak signals from background noise.

Vibration Sensor Variations. Vibration sensor 100 is not limited to the embodiments presented, but may be modified in many diverse ways, for example, providing unique configurations of sensor 100 for the many applications that are known to those familiar with the art. By way of example, only a few modifications of sensor 100 will now be presented.

In an exemplary embodiment, housing 110 comprises an upper section 142, a lower section 144 and a middle section 140. Alternatively, housing 110 is manufactured in one piece, for example using injection molding techniques.

As shown, X bores 170 and 176 and Y bores 180 and 186, are located in middle section 140 while Z bore 190 is located in upper section and Z bore 196 is located in lower section 144.

Additional pairs of bores (not shown) provide additional signal information to signal interpreter 102

Additionally or alternatively, three or more axes 172, 182 and 192 may pass through bores 170,176, 180, 186, 190 and 106 at different angles for specific uses. To detect vibrations emitted from a distance, for example in detecting buried pipes supplying water, sensor 100 is optimally configured with multiple axes passing from upper section 142 to lower section 144 each at angles of between 0 and 90 degrees.

Alternatively, sensor 100 may include two pairs of transducers 160 along X-axis 172 and Y-axis 182 axes, accruing greater sensitivity to the signal information provided to signal interpreter 102.

Bores 170,176, 180, 186, 190, and 196 along with their respective transducers 160 communicate with outside volume 112, and, together with the glue mentioned above, seal chamber 150. Alternatively, transducers 160 are mounted upon the inner surface of chamber 150 or embedded in housing 110 so that transducing elements 162 are recessed into surface 154.

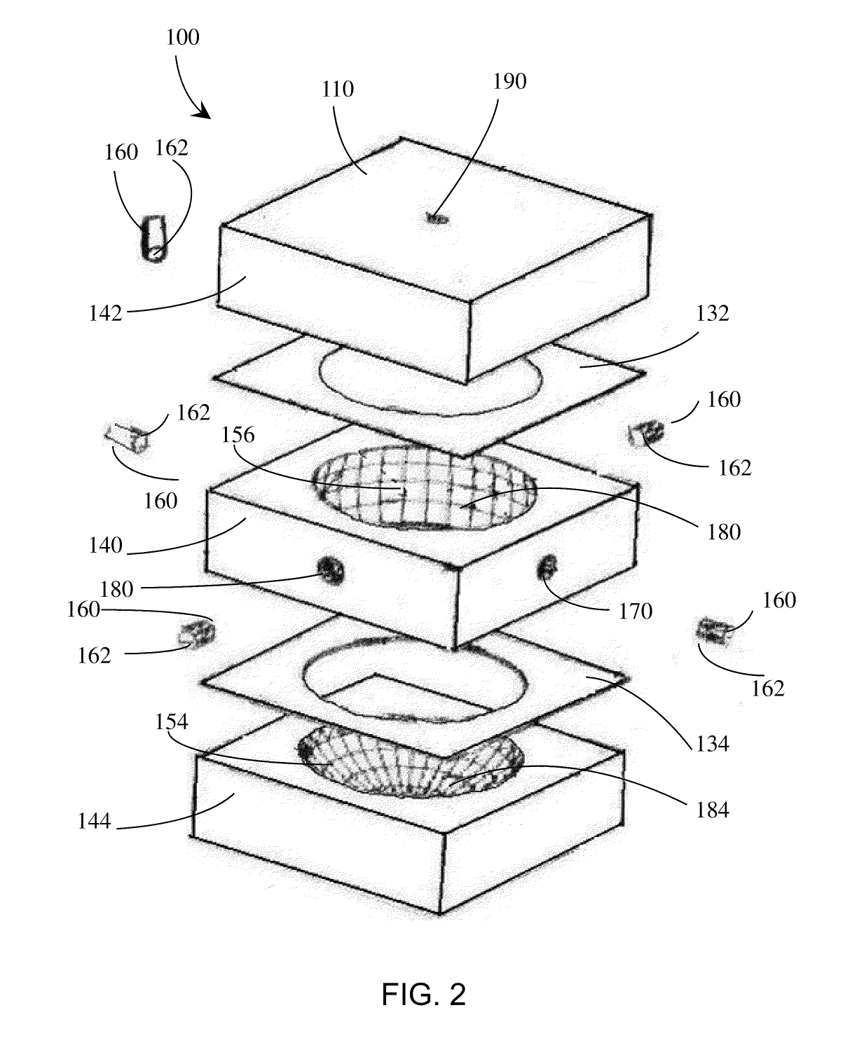

Proceeding to FIG. 2, sensor 100 is shown in an exploded view and includes an upper compressible gasket 132 between upper 142 and middle 140 sections; and a lower compressible gasket 134 between middle 140 and lowers 144 sections.

Gaskets 152 and 154, for example, comprise a compressible and/or flexible rubber material so that when bolts (not shown) extend vertically through the corners of sections 140, 142 and 144, gaskets 152 and 154 are compressed to seal chamber fluid 152 from outside volume 112.

Additionally or alternatively, gaskets 152 and 154 include upper and lower surfaces that adhere to adjacent surfaces of sections 140, 142 and 144, thereby aiding in sealing chamber 150.

Transducers 160 are shown having a cylindrical cross-section. Alternatively, transducers 160 have a rectangular cross-section, an elliptical cross-section, or other cross sectional shapes depending, for example, on the type of transducer 160 and/or application.

Additionally, the composition of fluid 152 varies depending upon the inertial mass characteristics required for a given application. For example, a high density fluid 152 such as liquid mercury may be required in some applications. Other applications are best served by particles, for example, a powdered metal alone or, for example, suspended in fluid 152; the many options for fluid 152 having specific characteristics being well know to those familiar with the art

In some embodiments, fluid 152 substantially fills chamber 150 while in other embodiments, chamber 150 is partially filled. For example, in some embodiments, fluid fills 90% of chamber 150 to allow fluid 152 to expand due to anticipated temperature fluctuation.

In some embodiments, chamber 150 has a surface 154 that is substantially spherical while in other embodiments, surface 154 comprises several flat, intersecting planes, for example comprising a tetrahedron.

The many uses and embodiments of sensor 100, whether detection of seismic reflections, energy reaching a space station, or locating tunnel activity, are well known to those familiar with the art.

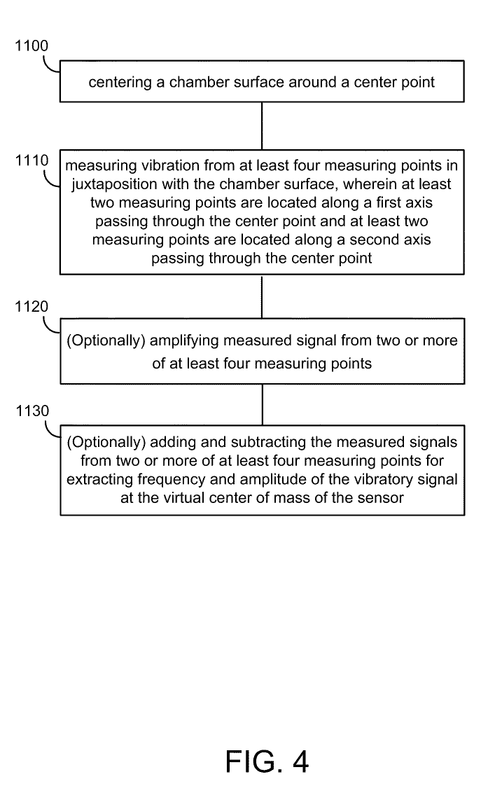

FIG. 4 is a high level flowchart showing a method of measuring a vibratory signal according to some embodiments of the present invention. Embodiments of the method may comprise: centering a chamber surface around a center point 1100; measuring vibration from at least four measuring points in juxtaposition with the chamber surface, wherein at least two measuring points are located along a first axis passing through the center point and at least two measuring points are located along a second axis passing through the center point 1110; Optionally, amplifying measured signal from two or more of at least four measuring points 1120; and further optionally, adding and subtracting the measured signals from two or more of at least four measuring points for extracting frequency and amplitude of the vibratory signal at the virtual center of mass of the sensor 1130.

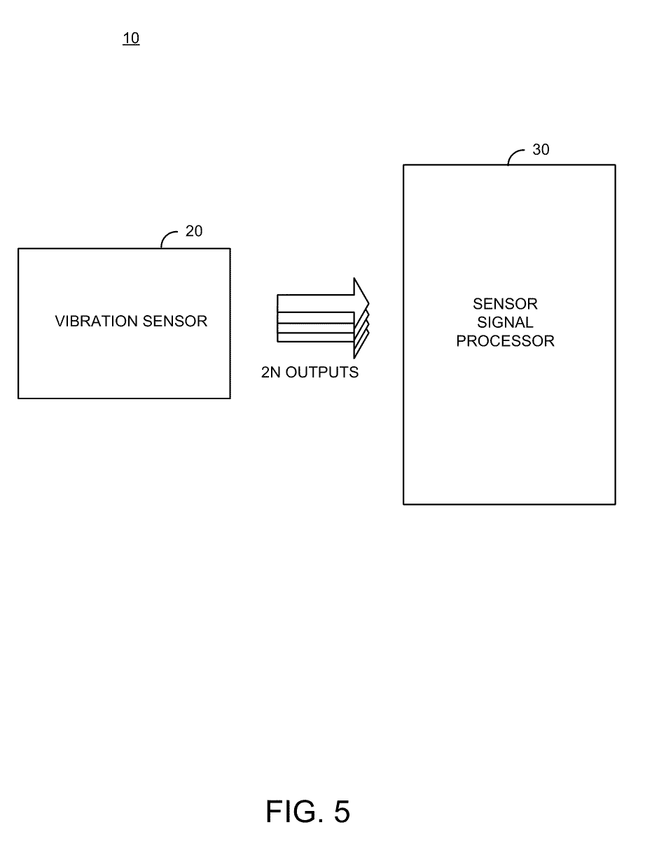

FIG. 5 is a high level block diagram illustrating a vibration measurement system according to some embodiments of the invention. The system 10 comprises a vibration sensor 20 coupled to a sensor signal processor 30.

In operation, system 10 is capable of measuring a plurality of axial components of a tempo spatial vibratory signal in a single virtual point wherein measuring is conducted in several points proximal to the virtual point but not at the virtual point. This is achieved by measuring vibrations along a plurality of N>2 axes and generating a plurality of 2N outputs. The 2N outputs may include N pairs of outputs corresponding to the N axes, respectively. For example, a pair of outputs corresponding to an axis of the N axes may include a pair of values corresponding to a pair of vibration measurements along the axis. Sensor signal processor 30 is capable to process the axial components of the tempo spatial vibratory signal and produce in turn characterizing parameters of the vibratory signal such as frequency and amplitude. Specifically, sensor signal processor 30 may be arranged to generate one or more vibration output results based on one or more of the 2N output signals. For example, the results may include values corresponding to vibrations, e.g., magnitude, frequency and/or vector, along one or more of 2N axes.

Optionally, Sensor signal processor 30 provides at least one of adding and subtracting the signals generated by each of the at least two pairs of transducers.

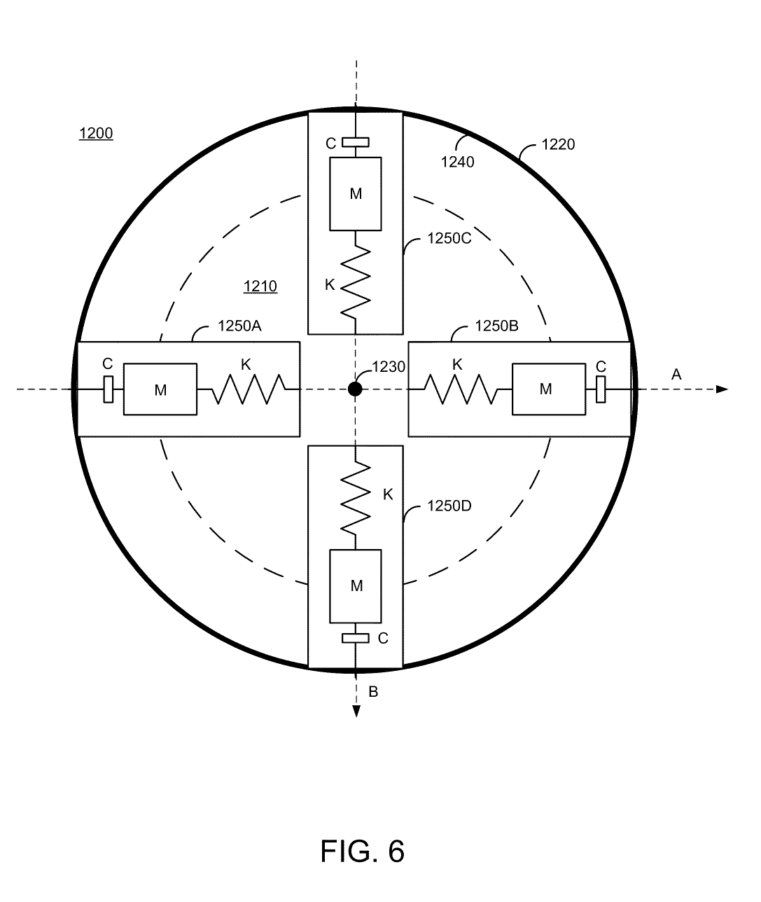

FIG. 6 is a high level mechanical diagram illustrating a vibration sensor 1200 according to some embodiments of the invention. Vibration sensor 1200 is arranged such that substantially all of the vibration measurements may be measured with respect to a single virtual mass center. Specifically, vibration sensor 1200 may provide the 2N outputs substantially simultaneously.

Vibration sensor 1200 may include a chamber 1210 within a housing 1220. Chamber 1210 may include a center 1230 and surface 1240 in which all portions of the surface are substantially equidistant from chamber center 1230, e.g., as described below. Vibration sensor 1200 may also include two or more pairs of vibration-sensitive transducers 1250A-1250D, wherein each transducer of each of the two or more pairs is adapted to communicate with at least one signal interpreter (not shown). Each of transducers 1250A-1250D has a body including a first end portion, a second end portion and a central axis segment passing axially through the center of the body, between the first end portion and the second end portion.

The first end portion is operatively associated with chamber surface 1240 and includes a transuding element receptor portion. The second end portion is in operative association with the housing and each transducer pair of the two or more transducer pairs 1250A-B and 1250C-D includes an axis passing through the central segment of a first transducer, the chamber center, and the central segment of a second transducer.

In an exemplary embodiment, the axes of the two or more transducer pairs 1250A-B and 1250C-D are planar and at least one first axis passing through at least one first transducer pair is at least one of perpendicular and obliquely angled, with respect to at least one second axis passing through at least one second transducer pair.

Alternatively, the at least two transducer pairs 1250A-B and 1250C-D may comprise at least three transducer pairs, and the at least one third transducer pair that is at least one of the planar and oblique with respect to the plane of the at lest two planar transducer pairs and the at least one third transducer pair axis is perpendicular to the plane of the at least two transducer pairs 1250A-B and 1250C-D.

Optionally, the at least three transducer pairs may comprise at least four transducer pairs, and include at least one fourth transducer pair angled 45 degrees to the two or more planar axes.

Optionally, each transducer of at least one transducer pair includes amplification housing.

Specifically, vibration sensor 1200 as illustrated in FIG. 6 illustrates a vibration sensor capable of measuring vibrations along N=2 axes, the axes are denoted A and B, respectively.

More particularly, vibration sensor 1200 may comprise a chamber 1210 within a housing 1220. Chamber 1210 may be limited by a chamber wall surface 1240. Vibration sensor 1200 may include a plurality of 2N transducers 1250A-D mounted to chamber wall surface 1240, such that each pair of transducers 1250A-D is mounted along a respective axis of the N axes. For example, as shown in FIG. 6, vibration sensor 200 may include a first pair of transducers 1250A-B mounted to chamber surface wall 1240 along axis A, and a second pair of transducers 1250C-D mounted to chamber surface wall 1240 along axis B. Chamber surface wall 1240 may include, for example, a substantially rigid wall, e.g., a spherical vibration-transmitting chamber wall. The transducers may be mounted to chamber surface wall 1240 using any suitable mounting method or element.

Transducers 1250A-D may include any suitable type of Mass-spring transducer, as are known in the art and comprising a spring K coupled to a damper C via a mass M.

Substantially all 2N transducers 1250A-D may be located symmetrically with respect to a virtual mass center 1230. For example, a center of mass of the inertial masses, denoted M, of each of the transducers may be located at a predefined distance from virtual mass center 1210.

Substantially all of the 2N transducers may have substantially identical properties. In one example, 2N transducers may include 2N identical transducers.

As shown in FIG. 6, each pair of transducers 1250A-B and 1250C-D may include two transducers mounted to chamber surface wall 1240 at opposite sides of axes A and B, respectively.

A virtual center of mass in which a mass connected at opposite sides with springs to a common solid frame oscillating around its center of mass can be split into two separate masses which will continue to oscillate around the same virtual center of mass. Accordingly, each of the transducer pairs 1250A-B and 1250C-D may measure vibrations representing vibrations along axes A and B, respectively, of a signal mass located at virtual mass center 1230.

In one example, each of the transducers may have a body including a first end; a second end; and a central axis segment between the first and second ends that passing through the center of the body, each body including a port adapted to communicate with a signal interpreter. Each first transducer end may be operatively associated with the housing. Each second transducer end includes a transducing element operatively associated with the chamber surface wall 1240.

In an exemplary embodiment, transducer pair 1250A-B and transducer pair 1250C-D are paired around chamber 1210 so that a first axis passes through a first transducer of each pair, the center of the chamber and through a second transducer of each pair; the first and second transducer pairs providing vibration information from virtual mass center 1240.

In exemplary embodiment, the axes passing through the first and second transducer pairs are planar and perpendicular to each other. Planar axes, as used herein, may refer to axes that lie along a single flat plane.

One or more of the transducers may include an amplification housing to amplify the vibrations.

Transducers 1250A-B and 1250C-D may generate 2*2=4 output signals. E.g., corresponding to the output signals described above with reference to FIG. 5. The sensor signal interpreter of FIG. 5 may use the output signals of transducers 1250A-B and 1250C-D, e.g., to characterize vibrations in magnitude, frequency and/or vector along axes A and/or B.

Although the above description refers to a vibration sensor including two pairs of transducers 1250A-B and 1250C-D to measure vibrations along two axes A and B, in other examples the sensor may include any other suitable numbers of pairs and transducers to measure vibrations along any other suitable number of axes. For example, the sensor may implement three pairs of transducers located along at least three axes, which may be perpendicular to each other and thereby characterize vibrations in the X, Y, and Z axes.

In the example described above the axes can be orthogonal to each other. In other example the axes may include two or more non-orthogonal axes, e.g. if N>3.

Although FIG. 6 illustrates a spherical chamber surface wall 1240, in other examples the chamber wall may have any other suitable shape. Moreover, location of the transducer need not necessarily be equidistant respective of the center. Rather, each transducer may thus be located in a distance from the center that is in reverse proportion to the mass of each particular transducer. This ensures the differential measuring of vibration signals in a plurality of axes.

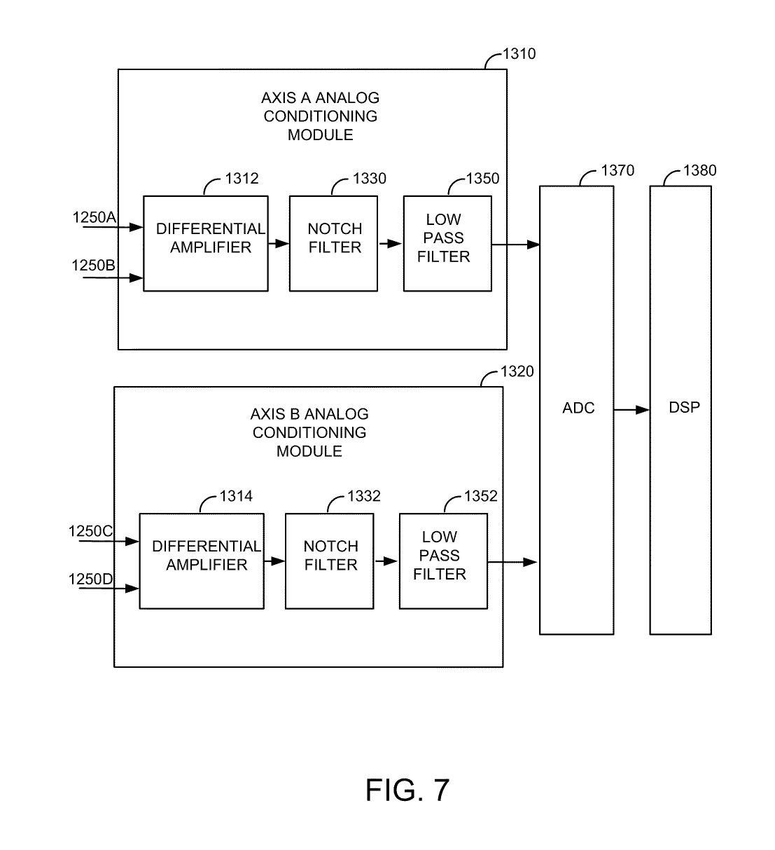

FIG. 7 is a high level schematic block diagram showing a sensor signal processor 30 according to some embodiments of the invention. The shown signal processor is capable of processing signals measured by two pairs of transducers within the vibration sensor, each pair located on a different axis crossing the center of the vibration sensor. Specifically, sensor signal processor 30 comprises an axis A analog conditioning module 1310 and an axis B analog conditioning module 1320, each analog conditioning module 1310 and 1320 comprises differential amplifiers 1312-1314 fed by two transducer pairs 1150A-B and 1150C-D, a notch filter 1330 and 1332, and a low pass filter 1350 and 1352. The outputs of axis A analog conditioning module 1310 and axis B analog conditioning module 1320 are fed to an analog to digital converter 1370 and in turn to a digital signal processor 1380.

In operation, each differential amplifier is capable of subtracting two signals arriving from the same pair and further delivering the differential signal for further extraction of frequency and amplitude of the vibratory signal by digital signal processor 1380.

According to some embodiments of the invention, Sensor signal processor 30 can be implemented in digital electronic circuitry, or in computer hardware, firmware, software, or in combinations thereof.

Sensor signal processor 30 can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions for processing tempo spatial vibratory signals include, by way of example, digital signal processors (DSPs) but also general purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. The processor and the memory can be supplemented by, or incorporated in, ASICs (application-specific integrated circuits).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A vibration sensor enabling measuring a vibratory signal in a single virtual center of mass of the sensor comprising:
a housing;
a chamber within the housing exhibiting a chamber center and a chamber surface wherein all portions of the chamber surface are substantially equidistant from the chamber center; and
at least two pairs of vibration-sensitive transducers each pair comprising a first and a second transducers,
wherein each transducer has a body including a first end portion, a second end portion and a central axis segment passing axially through the center of the body, between the first end portion and the second end portion;
and wherein the first end portion is operatively associated with the chamber surface and includes a transuding element receptor portion;
and wherein the second end portion is in operative association with the housing and each transducer pair of the two or more transducer pairs;
and wherein the central segment of a first transducer, the chamber center, and the central segment of a second transducer are located on a common axis.

2. The vibration sensor according to claim 1, wherein the axes of the two or more transducer pairs are planar and at least one first axis passing through at least one first transducer pair is at least one of perpendicular and obliquely angled, with respect to at least one second axis passing through at least one second transducer pair.

3. The vibration sensor according to claim 1, wherein the at least two transducer pairs comprise at least three transducer pairs, and the at least one third transducer pair that is at least one of the planar and oblique with respect to the plane of the at lest two planar transducer pairs and the at least one third transducer pair axis is perpendicular to the plane of the at least two transducer pairs.

4. The vibration sensor according to claim 3, wherein the at least three transducer pairs comprise at least four transducer pairs, and include at least one fourth transducer pair angled 45 degrees to the two or more planar axes.

5. The vibration sensor according to claim 1, wherein each transducer of at least one transducer pair further includes amplification housing.

6. The vibration sensor according to claim 1, wherein the transducers comprises a mass-spring transducer comprising a spring coupled to a damper via a mass.

7. The vibration sensor according to claim 1, wherein substantially all 2N transducers are located symmetrically with respect to a virtual mass center.

8. The vibration sensor according to claim 7, wherein the transducers are located at a predefined distance from the virtual mass center.

9. The vibration sensor according to claim 7, wherein the transducer pairs are paired around the chamber so that a first axis passes through a first transducer of each pair, the center of the chamber and through a second transducer of each pair; the first and second transducer pairs providing vibration information from the virtual mass center.

10. The vibration sensor according to claim 7, wherein the axes passing through the first and second transducer pairs are planar and perpendicular to each other.

11. The vibration sensor according to claim 1, further comprising a sensor signal processor comprising differential amplifying functionality arranged to:
subtract two signals arriving from the each pair of transducers; and
process the differential signals for extraction of frequency and amplitude of the vibratory signal at the virtual center of mass of the sensor.

12. A method of measuring a vibratory signal in a single virtual center of mass of a vibration sensor, the method comprising:
centering a chamber surface around a center point; and
measuring vibration from at least four measuring points in juxtaposition with the chamber surface, wherein at least two measuring points are located along a first axis passing through the center point and at least two measuring points are located along a second axis passing through the center point.

13. The method according to claim 12, further comprising amplifying measured signal from two or more of at least four measuring points.

14. The method according to claim 12, further comprising applying differential amplification on each two measured signals from each pair of points resulting in differential signals.

15. The method according to claim 14, further comprising processing the differential signals from the pairs of points for extracting frequency and amplitude of the vibratory signal at the virtual center of mass of the sensor.
